(19) United States
(12) Patent Application Publication
(10) Pub. No.: US 2004/0091395 A1
(43) Pub. Date: May 13, 2004

(54) Tray for automated histochemical processing

(75) Inventors: Glen Ward, Tucson, AZ (US); Kendall B. Hendrick, Tucson, AZ (US); Vince Rizzo, Tucson, AZ (US)

Correspondence Address: VENTANA MEDICAL SYSTEMS, INC., 1910 INNOVATION PARK DRIVE, TUCSON, AZ, 85737, US

(73) Assignee: Ventana Medical Systems, Inc.

(21) Appl. No.: 10/621,761

(22) Filed: Jul. 16, 2003

Related U.S. Application Data
(60) Provisional application No. 60/396,837, filed on Jul. 16, 2002.

(51) Int. Cl. B01L 9/00

(52) U.S. Cl. 422/63; 422/104

(57) ABSTRACT

The invention is the combination of a rectangular-shaped tray adapted to hold one or more removable slide frames which orient the slides horizontally, the combination also functioning to accurately and reproducibly align the slides for automated processing. The slide tray has molded features that positively hold the slide frames in place. The slide frames are removable so that the histotechnician may load the five or so slides that each frame holds in groups of five. The frames are removable to facilitate loading of slides and cleaning of the tray. A related invention is a slide tray for holding microscope slides substantially horizontally for automated chemical processing, comprising a tray having a floor and integral means for holding slides securely and fixedly positioned on said floor.

### BACKGROUND

1. Field of the Invention

The invention is in the field of automated slide staining, more particularly it is a tray for holding microscope slides that are to be stained in an automated microscope slide staining apparatus.

2. Background of the Invention

Tissue staining for the purpose of diagnosing pathological conditions is an ancient art by modern standards that goes back over one hundred years. Traditionally practiced by hand, the ranks of Histotechnologists have declined as a result of a decrease in the number of applicants for available positions. Because of this decrease in qualified labor and other reasons, efforts have been made to automate the steps involved in applying different types of chemical and biochemical stains to tissue sections. Instruments that have been invented for this purpose include the Ventana Medical Systems' line of dual carousel-based instruments such as the 320, ES®, NexES®, BENCHMARK®, and the BENCHMARK® XT. Patents that describe these systems include U.S. Pat. Nos. 5,595,707, 5,654,199, 6,093,574, and 6,296,809, all of which are incorporated herein by reference in their entirety. Another type of automated stainer is the TechMate® 500/1000 line of stainers, described in U.S. Pat. Nos. 5,355,439 and 5,737,499, both of which are incorporated herein by reference in their entireties.

One of the Histology laboratory standards that has developed over the years is the use of a cardboard folder for the organization and presentation of finished stained slides so that the Pathologist reading the slides to determine a patient's status can efficiently keep track of the sample slides. Microscope slides are 1″ by 3″, and the tray folder accommodates 20 such slides. The folder is approximately 14 by 7 inches, and has a center storage, and left and right folding portions.

There is a need to provide new automated histochemical processing devices for the histology laboratory that fit into the existing workflow environment.

### SUMMARY OF THE INVENTION

The invention is the combination of a rectangular-shaped tray adapted to hold one or more removable slide frames which orient the slides horizontally, the combination also functioning to accurately and reproducibly align the slides for automated processing. As seen in the Figures, the slide tray has molded features that positively hold the slide frames in place. The slide frames are removable so that the histotechnician may load the five or so slides that each frame holds. The frames are removable to facilitate loading of slides and cleaning of the tray. In the present embodiment, each tray holds four slide frames, but the trays could hold any number of frames as long as the automated stainer is adapted to process the tray.

The invention is directed to a tray-and-slide-frame combination for holding microscope slides horizontally for automated chemical processing, comprising a tray having four sides and a bottom, the bottom having means for locating and positioning slide frames within it; and at least one removable slide frame for holding at least one slide independent of the tray, the slide frame comprising a beam and means for grasping the slides.

The invention is also directed to a unitary slide tray for holding microscope slides substantially horizontally for automated chemical processing, comprising a tray having four sides and a floor and integral means for holding slides securely and fixedly positioned on said floor.

It is an object of the invention to provide a slide holder for automated chemical processing of tissue samples.

### BRIEF DESCRIPTION OF THE DRAWINGS

FIG. 1 is an elevational view of a drawing of the top of the overall inventive combination of tray and slide frames, with slides installed.

FIG. 2 is a bottom elevational view of a drawing of the tray.

FIG. 3 is a top elevational view of the slide frame with 2 of 5 positions occupied by slides.

FIG. 4 is a bottom elevational view of the slide frame with 2 of 5 positions occupied by slides.

FIG. 5 is a top elevational view of the second tray embodiment.

FIG. 6 is a bottom elevational view of the second tray embodiment.

FIG. 7 is a top elevational view of the retaining post of the second tray embodiment.

### DESCRIPTION OF THE PREFERRED EMBODIMENTS

The invention is the combination of a rectangular-shaped tray adapted to hold one or more removable slide frames which orient the slides horizontally, the combination also functioning to accurately and reproducibly align the slides for automated processing. As seen in the Figures, the slide tray has molded features that positively hold the slide frames in place. The slide frames are removable so that the histotechnician may load the five or so slides that each frame holds. The frames are removable to facilitate loading of slides and cleaning of the tray. In the present embodiment, each tray holds four slide frames, but the trays could hold any number of frames as long as the automated stainer is adapted to process the tray. Commonly owned U.S. patent application serial No. 60/372,506 filed Apr. 15, 2002, and U.S. Ser. No. 10/414,804 filed Apr. 15, 2003 describes the automated stainer that this tray is designed for, and they are incorporated herein by reference in their entirety.

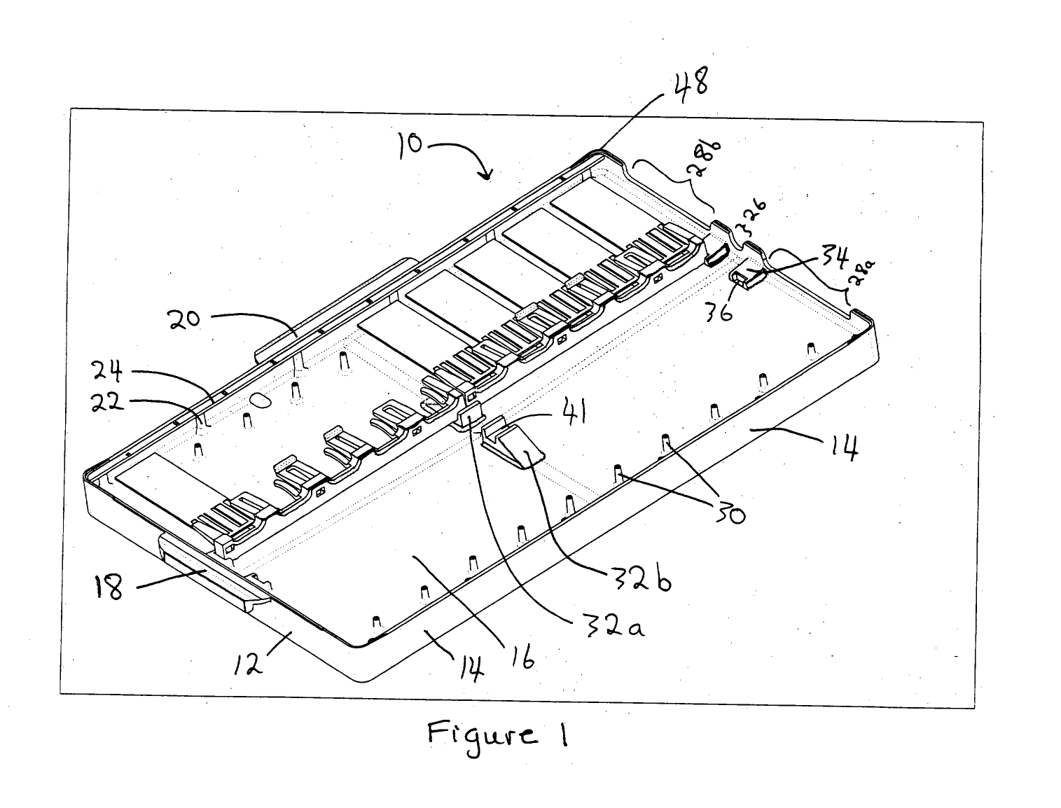

FIG. 1 shows the overall inventive combination. Tray 10 contains the slides that are in turn held by the slide frames 50. The tray and slide frames are injection molded using a dimensionally stable thermoplastic such as ULTEM™ 1000 (General Electric). In the presently preferred embodiment, the slides are held in groups of five in each slide frame, although the invention is readily adaptable to any number of slides given the physical constraints of the automated stainer. FIG. 1 depicts two of the four possible slide frames present. The slide frame occupying the upper right quadrant is full, and the slide frame in the upper left quadrant has one slide in it. The two lower quadrants are empty to show the features disclosed therein. The slides are held in place at one end by a spring and slide retainer combination that serves to locate the slide as it is being loaded into the frame, and positively aligns the slide against the retainer without any alignment effort on the part of the technician. The other (outboard) end of the slide is supported by a single post.

With specific attention to FIG. 1, tray 10 has a shallow, rectangular open top design. It has short and long sides 12, 14, respectively, and a floor 16. The floor is divided into four sectors or quadrants which are sloped from the walls to the center so that liquid reagents and wash buffers may drain toward the center where they are aspirated out by an aspirator tube (not shown). X-handle 18 and Y-handle 20 are rail-like projections that are gripped by the autostainer to move the tray in x- and y-dimensions. Splash rail posts 22 are integrally molded into the tray and are adapted to receive and anchor the splash rail 24. Splash rail 24 is a separate molded part that has projections that engage the splash rail posts, thus aligning and anchoring the splash rail. The function of the splash rail is to prevent wash solutions from spilling out of the tray during the rinse function.

The tray 10 has cutouts 26 and 28 that allow access by the aspirating tube (26) and for airflow (28a, 28b). The aspirating tube (not shown) functions to suck liquids from the floor of the tray, as previously mentioned. Tray 10 has slide support posts 30 which are vertical projections that function to support the slide at the end of the slide distant from the bar code in the center of the slide. The tops of the posts are co-planar, but the posts lengths must vary due to the sloping floor of the tray. It is important that the posts are at a height that defines a slight downhill pitch from the bar code end, or interior of the tray, to the sample end, or outside of the tray. The preferred range of pitch is 0-0.5 degrees, and the most preferred pitch is 0.25 degrees.

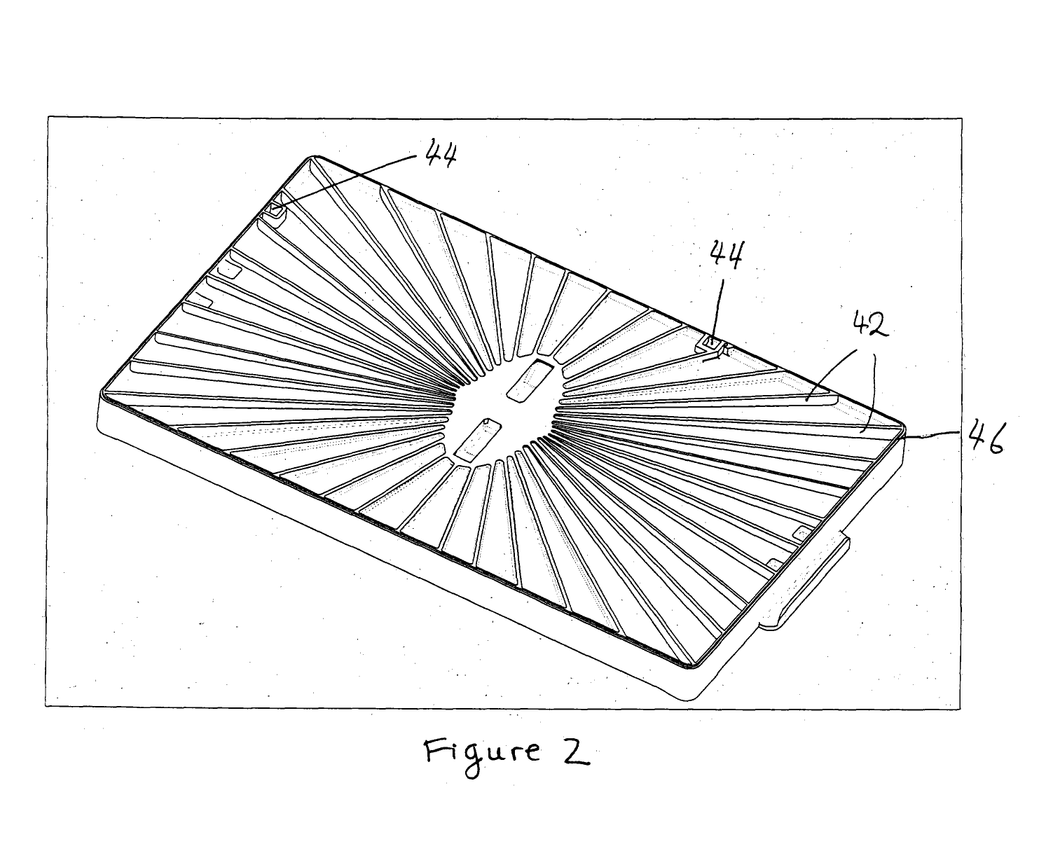

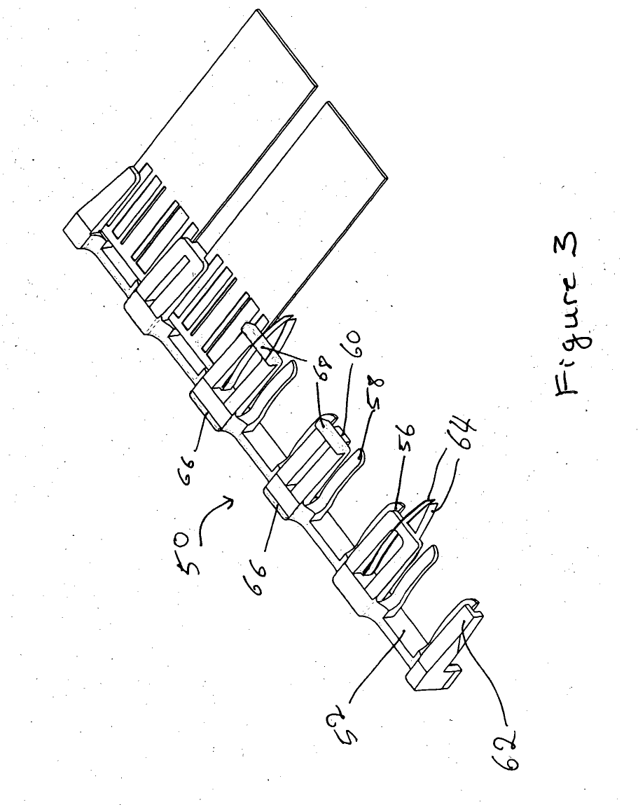

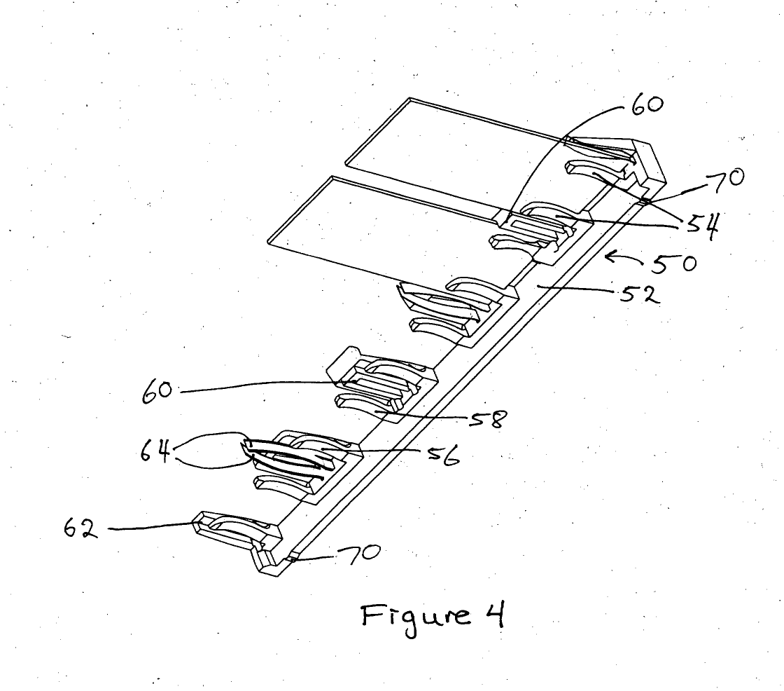

The slide frames 50 are held in place on the tray 10 by inner and outer slide frame supports. Again with attention to FIG. 2, in the center of the tray 10 is located molded features 32a and 32b, left and right slide frame supports, respectively. 32a and 32b are identical, but are rotated 180 degrees in relation to each other. They have left and right notches 40, 41, respectively, that receive and support the ends of four slide frames 50 in the middle of the tray. The other ends of the slide frames are received and supported by outer slide frame supports 34 having notches 36. The notches do not meet the floor of the tray, but rather are elevated above the floor some distance to allow for clearance of the slide frame nubs 70 (See FIGS. 3-4).

FIG. 2 depicts the bottom of the tray 10. The most prominent feature are the ribs 42. The ribs are formed through the injection molding process, and provide rigidity to the tray. Magnet holders 44 are cavities formed to hold magnets that are used in locating the tray in the automated stainer device into which the tray goes. Corner tongues 46 are inner projections located in each of the corners and interlock with corner grooves 48 (FIG. 1) when trays are stacked so that trays may be stacked one upon the other in a stable fashion.

FIGS. 3 and 4 are elevational perspectives that show the slide frame 50 from above and below. With specific reference to those figures, slide frame 50 has a main beam 52 which functions as the backbone to anchor all of the retaining features of the slide frame. Each slide is held in place by a combination of leaf springs 54, which are comprised of two leaf spring fingers 56, 58, respectively, and slide retainers 60 and/or 62. If the slide is located internally, it will be retained by two internal retainers 60. If the slide is located on the exterior of the frame, it will be retained by a combination of one internal retainer 60 and one external retainer 62. The retainers function as corners that the rectangular slides seat against on the side and on the top, positively locating them for proper alignment for subsequent processing. Locator springs 64 function to urge the slide into contact with the retainer corners 60 or 62 as they are being slid into the slide frame by the technician. Finger grips 66, 68 provide purchase for grasping of the slide frame when loaded. Locating nubs 70 are projections on the bottom of the beam 52 which provide a stop of the frame when it is seated in the tray. The nubs are positioned to limit movement of the slide frame longitudinally by abutting the slide frame supports when the frames are sitting in the tray.

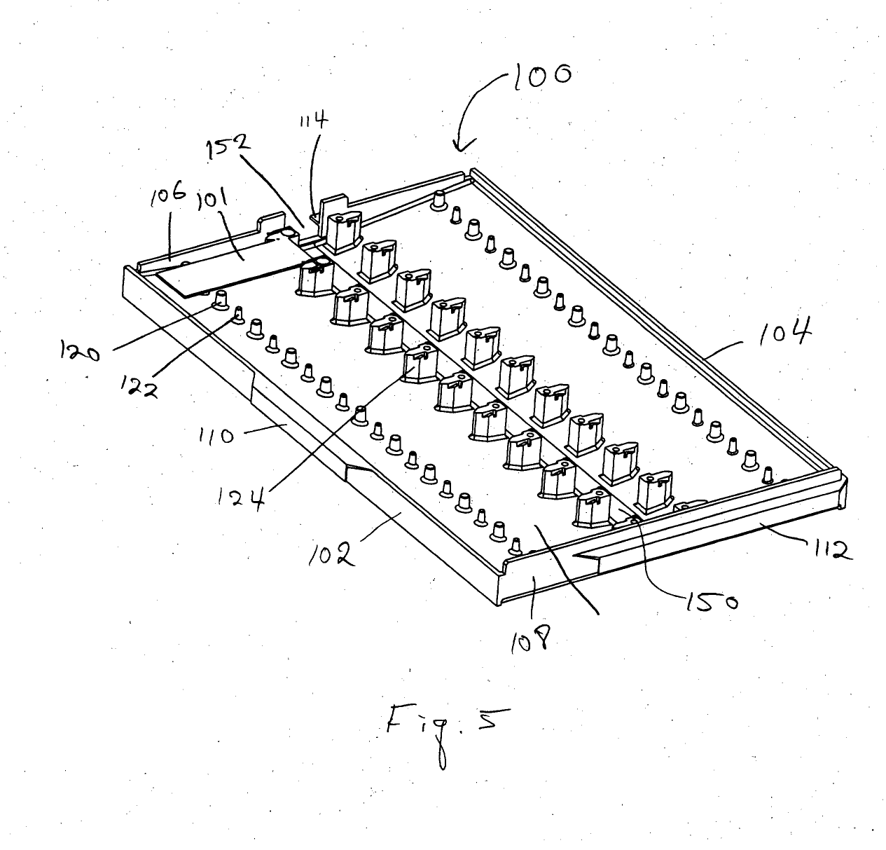

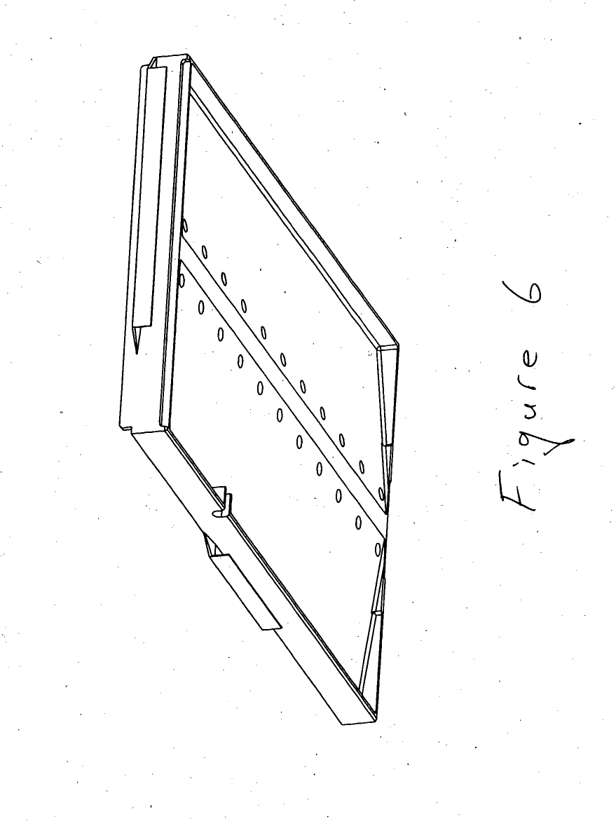

A second preferred embodiment of the slide tray of the present invention is shown in FIGS. 5-7. In this embodiment, the slide frame has been omitted, and instead the slide holding features are now built into the slide tray itself in one integral, molded component, simplifying the overall manufacture of the tray. As seen in more detail in FIG. 5, tray 100 has four sides and a floor that slopes into a middle channel, thereby allowing liquid reagents to run off the slides and pool in the channel formed there. Left edge 102, right edge 104, back edge 106 and front edge 108 form the periphery of the tray. Floor 116 meets the edges to form the tray body. As previously mentioned, the tray floor slopes from the left and right sides to the middle where there is a floor drain channel 150. Again with particular attention to FIG. 5, the tray has gripping and locating features such as a hook-rail 112 for machine grasping of the tray at its front. Y hook 110 is similarly used for positioning the tray, while rail 114 is an alignment feature that functions to prevent mis-loading of a tray by the operator into the storage garage (not shown).

The tray is preferably formed from a lightweight plastic material, as mentioned above in regard to the first embodiment, or most preferably a lightweight metal such as extrusion-molded magnesium or aluminum. The tray has molded features for supporting the slides in precise positions so that they will be properly positioned for the automated nozzles and aspirators which apply and wash reagent to and from the sample surfaces. Each slide 101 is supported at three points-one outboard, and two inboard. The term “inboard” indicates the feature is located toward the middle of the tray, while “outboard” refers to the feature being located towards the outside of the tray. The first is support post 122, which is located on the outboard edge of the tray, and is located so that it physically abuts the underside of its respective slide in the midline area of the slide 101. Support post 122's height is designed so that a 0.4 to 0.8 degree slope with respect to a hypothetical flat floor is obtained, allowing for optimal retention of reagent. Retaining post 124 is the other point of support, and each retaining post supports two slides at their inboard edges. Positioning post 120 does not support a slide, but does provide a lateral barrier beyond which the slide may not move. Positioning post 120 is 0.020″ higher than the bottom of the edge of the slide, and each slide is constrained by two of these at the outboard edge of the tray.

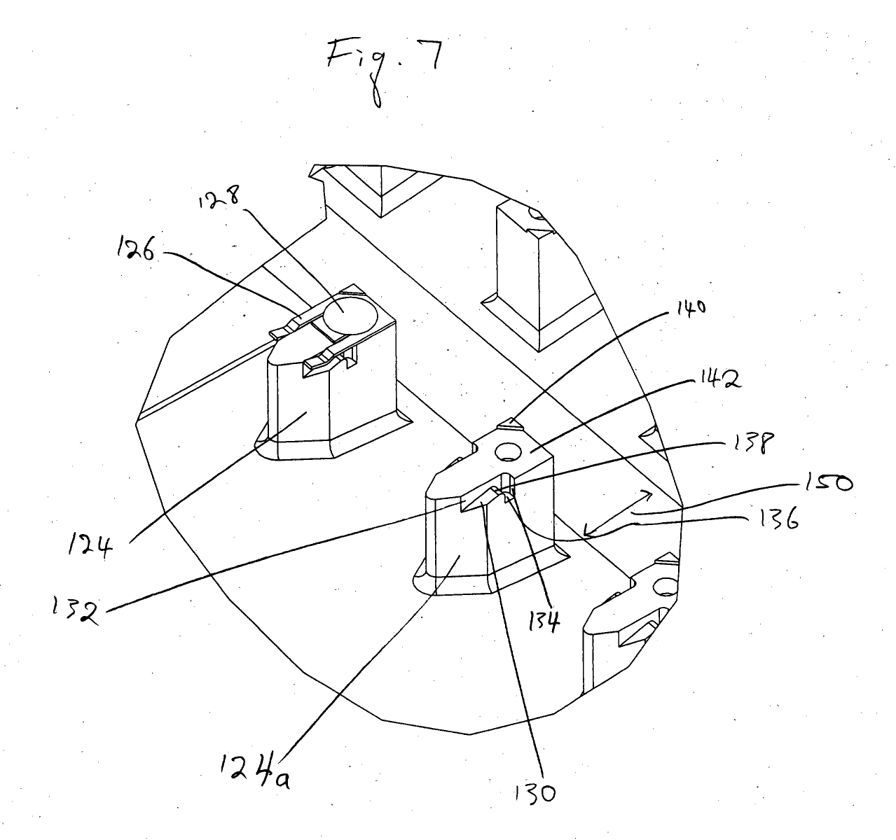

FIG. 7 shows greater detail of positioning post 124. With specific attention to FIG. 7, the left positioning post 124 and the right positioning post 124a vary in that the spring clip 126 and spring clip fastener 128 are omitted for illustration purposes only in 124a. In normal operation, the retainer and fastener will be in place as shown by retaining post 124. Spring clip 126 is a one-piece metallic clip that secures the edges of a slide between the finger of the clip and the slide shoulder 138. Spring clip 126 is itself secured to the spring clip mounting surface 142 via a fastener 128. The fastener may be any conventional fastener such as a rivet or screw. The spring clip is oriented face-up by spring clip alignment feature 140, shown in FIG. 7 as a raised portion of the top of the retaining post 124/124a. The alignment feature mates with the clip so that when the clip is installed, the clip must be oriented so that the clip fingers are oriented as depicted.

The retaining post has various features designed to accept, position and securely retain the edge of a slide. Those cutout features are shown as slide ramp 130, positioning wall 132, slide stop 134, slide shoulder 138, and spring clip 126. Slide ramp 130 and positioning wall 132 are cutouts that are angled to facilitate the positioning of a slide as it is slid inwardly towards the slide shoulder 138 and finally is stopped by slide stop 134. Spring clip 126 provides an upper boundary and pushes downwardly on the top of the corner of the slide to urge it into continuous contact with the slide shoulder 138. Retaining post drain channel 136 allows excess reagent to drain from that corner of the slide to the floor of the tray and then to floor drain channel 150.

The tray is designed to be used in horizontal orientation. Access to the inside of the tray by the rinse nozzle (not shown) is made possible by nozzle aperature 152, shown as the cutout in the back edge 106 of the tray.

Although certain presently preferred embodiments of the invention have been described herein, it will be apparent to those skilled in the art to which the invention pertains that variations and modifications of the described embodiments may be made without departing from the spirit and scope of the invention. Accordingly, it is intended that the invention be limited only to the extent required by the appended claims and the applicable rules of law.

We claim:

1. A tray-and-slide-frame combination for holding microscope slides horizontally for automated chemical processing, comprising
(a) a tray having four sides and a bottom, the bottom having means for locating and positioning slide frames within it; and
(b) at least one removable slide frame for holding at least one slide independent of the tray, the slide frame comprising a beam and means for grasping the slides.

2. The tray of claim 1 wherein means for locating slide frames comprises inner and outer slide frame supports, said supports having notches for receiving the slide frame beams, the means for locating further comprising nubs on the bottom of said slide frames.

3. The tray of claim 1 wherein the means for locating comprises magnets for enabling location of the tray within the automated staining apparatus.

4. The tray of claim 1 further comprising at least one slide support post per slide, said post projecting upwards from the floor of said tray for supporting each slide under the sample area of the slide.

5. The tray of claim 4 wherein the height of the slide support post is such that a downwards pitch of the slide from interior to exterior of the tray is from about 0 to about 0.5%.

6. The tray of claim 1 further comprising handles for grasping the tray and moving it within the automated stainer apparatus.

7. The tray of claim 1 further comprising means for stacking the tray.

8. A slide tray for holding microscope slides substantially horizontally for automated chemical processing, comprising
a) a tray having a floor; and
b) integral means for holding slides securely and fixedly positioned with respect to said floor.

9. The slide tray of claim 8 wherein said tray is rectangular.

10. The tray of claim 8 wherein said integral means for holding slides comprises slide support elements.

11. The tray of claim 10 wherein said slide support elements comprise a retaining post and a support post, said retaining post having means for securely positioning at least one corner of a slide, and said support post positioned on said tray floor to support the other end of said slide.

12. The tray of claim 11 wherein said retaining post is mounted on the inboard aspect of the tray, and said support post is mounted on the outboard aspect of the tray.

13. The tray of claim 11 wherein said retaining post has cutout features including a support shoulder that provides a vertical support for said slide.

14. The tray of claim 11 wherein said support post and said retaining post define a substantially horizontal plane when the slide is held in place by them.

15. The tray of claim 14 wherein said substantially horizontal plane tilts from about 0.8 degrees to about 0.4 degrees outboard.

16. The tray of claim 8 wherein said floor is sloped towards a longitudinal drain channel.

17. The tray of claim 10 wherein said tray additionally comprises a slide positioning element.

18. The tray of claim 17 wherein said slide positioning element comprises an outboard positioning post rising from said tray floor to a point above the bottom of said slide and also positioned to limit the slide's movement in the front-back direction.

19. The tray of claim 8 wherein said tray optionally includes sides.

20. A slide tray for holding microscope slides substantially horizontally for automated chemical processing, comprising
a) a tray having a floor; and
b) support and positioning elements for supporting each slide in substantially horizontal and spacially fixed orientation relative to each slide, said elements attached to the floor of the tray.

21. The slide tray of claim 20 wherein said support elements comprise a retaining post and a support post, said retaining post having means for securely positioning at least one corner of a slide, and said support post positioned on said tray floor to support the other end of said slide.

22. The tray of claim 21 wherein said retaining post is mounted on the inboard aspect of the tray, and said support post is mounted on the outboard aspect of the tray.

23. The tray of claim 21 wherein said retaining post has cutout features including a support shoulder that provides a vertical support for said slide.

24. The tray of claim 21 wherein said support post and said retaining post define a substantially horizontal plane when the slide is held in place by them.

25. The tray of claim 24 wherein said substantially horizontal plane tilts from about 0.8 degrees to about 0.4 degrees outboard.

26. The tray of claim 20 wherein said floor is sloped towards a longitudinal drain channel.

27. The tray of claim 20 wherein said slide positioning element comprises an outboard positioning post rising from said tray floor to a point above the bottom of said slide and also positioned to limit the slide's movement in the front-back direction.
